(19) United States
(12) Patent Application Publication
(10) Pub. No.: US 2002/0130895 A1
(43) Pub. Date: Sep. 19, 2002

(54) Method and apparatus for displaying help window simultaneously with web page pertaining thereto

(76) Inventors: Marcia Lynn Brandt, Rochester, MN (US); Joseph Vincent DiCecco, Rochester, MN (US); Jason Robert Hansen, Chatfield, MN (US); Thomas Michael Moskalik, Rochester, MN (US); Timothy Jude O'Keefe, Rochester, MN (US); Diane Elaine Olson, Rochester, MN (US); Devon Daniel Snyder, Rochester, MN (US)

Correspondence Address: IBM Corporation, Intellectual Property Law, Dept. 917, 3605 Highway 52 North, Rochester, MN, 55901-7829, US

(21) Appl. No.: 10/058,360

(22) Filed: Jan. 28, 2002

Related U.S. Application Data
(62) Division of application No. 08/806,136, filed on Feb. 25, 1997.

(51) Int. Cl. G09G 5/00

(52) U.S. Cl. 345/708

(57) ABSTRACT

In a web application, a user computer that executes a browser presents a help window on a monitor associated with the user computer, simultaneously with displaying portions of a web page obtained by the browser from a server, to enable a user of the user computer to view the help information without interfering with the user's interaction with the web page. The displayed help information pertains not to the browser itself, but to the web page.

This application is a divisional of U.S. patent application Ser. No. 08/806,136, filed Feb. 25, 1997, which is incorporated herein in its entirety by reference.

### BACKGROUND OF THE INVENTION

1. Field of the Invention

The present invention relates generally to computer networks, and more particularly to computer help features related to computer networks.

2. Description of the Related Art

Users of computers can access other computers to retrieve information using the Internet and portions thereof, such as the World Wide Web. To retrieve information using the web, a user invokes a software-implemented web browser that is resident in the user's computer to access another computer in the web referred to as a server computer. The server computer stores electronic web pages provided by one or more content providers. To access a particular web page, the user either clicks on an entry button associated with the web page (as might be provided in response to a search request), or the user inputs the uniform resource locator (URL) of the desired page. In either case, the server computer causes the desired page to be displayed on the monitor of the user's computer. The web page that is displayed to the user represents a software-implemented form that is coded in hypertext mark-up language (HTML). The form is shipped from the server to the browser in a file.

Traditionally, computer users can execute software-implemented applications and, during the execution of an application, invoke a “help” feature by appropriately manipulating a mouse or other input device. When the “help” feature is invoked, the application graphics displayed on the monitor are augmented with information pertaining to the operation and/or maintenance of the application. The information provided by a “help” function encompasses any kind of information that may be displayed. Such information may include tips, reference materials, tutorials, pictures, diagrams, and so on. The user can view the help information simultaneously with the application information to learn more about the application, and then the user can return to the application itself, and cause the monitor to cease displaying the help information.

However, when web pages are obtained, a user asks for help by clicking on a hypertext link to a topic of interest. The main work area of the web page is then replaced by the help information. A “back” button (or similar navigation mechanism) returns the user to the area of interest by deleting the help information from the display. This requires the user to remember relevant help information from one panel to the next, or to “flip” back and forth between the web page and the help information. Such operation is awkward and extracts a heavy penalty in terms of performance (machine and human) whenever help is required.

Manifestly, when using the World Wide Web, it is inconvenient not to be able simultaneously to view both a web page and the help page which pertains to it. As recognized herein, this is a particular drawback in Internet applications, wherein a user might wait several seconds for a screen display change to be completed.

### SUMMARY OF THE INVENTION

The present invention provides immediate help for a network user that is presented simultaneously with a web page to which it pertains, without replacing any part of the web page. In view of the above discussion, however, this invention recognizes that a help feature in a network context should be different than a help function that resides in a single-computer application. More specifically, this invention recognizes that it is desirable to provide for use with a web browser a help function that presents help information that pertains, not to the browser application itself, but to information being displayed on a web page obtained by the browser from a server computer.

Accordingly, it is an object of the present invention to provide a system and method for presenting a help window for information obtained from a network by a computer network browser. Another object of the present invention is to provide a system and method for presenting a help window simultaneously with the web page window that is being helped. Still another object of the present invention is to provide a system and method for presenting, on a user computer monitor, a help page window that pertains to a web page obtained from a server computer. Yet another object of the present invention is to provide a system and method for presenting a help window simultaneously with a web page window that is easy to use.

The invention is a general purpose computer programmed according to the inventive steps herein to present a help window with a web page display. The invention can also be embodied as an article of manufacture—a machine component—that is used by a digital processing apparatus and which tangibly embodies a program of instructions that are executable by the digital processing apparatus to present a help window with a web page display. This invention is realized in a critical machine component that causes a digital processing apparatus to perform the inventive method steps herein.

In accordance with a preferred embodiment, the method steps include presenting a page from a server computer on the monitor, with the server computer being remote from the user computer. Then, the method steps include receiving a help signal from the user computer, and allocating a portion of the monitor for a help window, in response to the help signal. Information is presented in the help window that pertains to the web page. In accordance with present inventive principles, the help window is displayed on the monitor simultaneously with at least a portion of the web page.

In a preferred embodiment, the help window includes a help frame, and a table of contents frame contiguous to the help frame and pertaining thereto. The table of contents frame presents hypertext links to HTML files pertaining to the web page. Also, the help window preferably further includes a navigation frame that is contiguous to at least one of the table of contents frame and the help frame. Desirably, the method steps are embodied in computer readable code means which are implemented in a computer network browser.

In another aspect, in a user computer connected via a wide area network to a server computer, a network browser is disclosed which includes computer readable code means for presenting a web page from the server computer on a monitor associated with the user computer. The present browser further inventively includes computer readable code means for selectively presenting a help window on the monitor associated with the user computer, with the help window containing information pertaining to the web page from the server computer and not to the browser.

In still another aspect, a software browser-implemented method is disclosed for presenting a help window on the display area of a monitor. The monitor is associated with a user computer, and the help window is displayed along with at least a portion of a web page from a server computer that is connected to the user computer via a wide area network. The method includes downloading the web page from the server computer and then receiving a help signal. In response to the help signal, only a portion of the display area is allocated for a help window. The method then includes presenting help information on the help window, and the help information pertains to the web page.

In yet another aspect of the present invention, a computer program product is disclosed which is readable by a digital processing apparatus and which tangibly embodies a computer program. The computer program product combines a computer readable medium with program code elements that present a help window on a web page display.

In this invention, the code elements are embodied in a program stored on the computer readable medium. These code elements include computer readable code means for presenting a web page from the server computer on the monitor that is associated with the user computer. Also, computer readable code means selectively present a help window on the monitor. Per the present invention, the help window contains information which pertains to the web page from the server computer, and not to the browser.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of the system of the present invention;

FIG. 2 is a schematic view of the help window of the present invention being displayed simultaneously with a web page; and

FIG. 3 is a flow chart of the steps for presenting the help window.

### DETAILED DESCRIPTION OF THE PREFERRED EMBODIMENTS

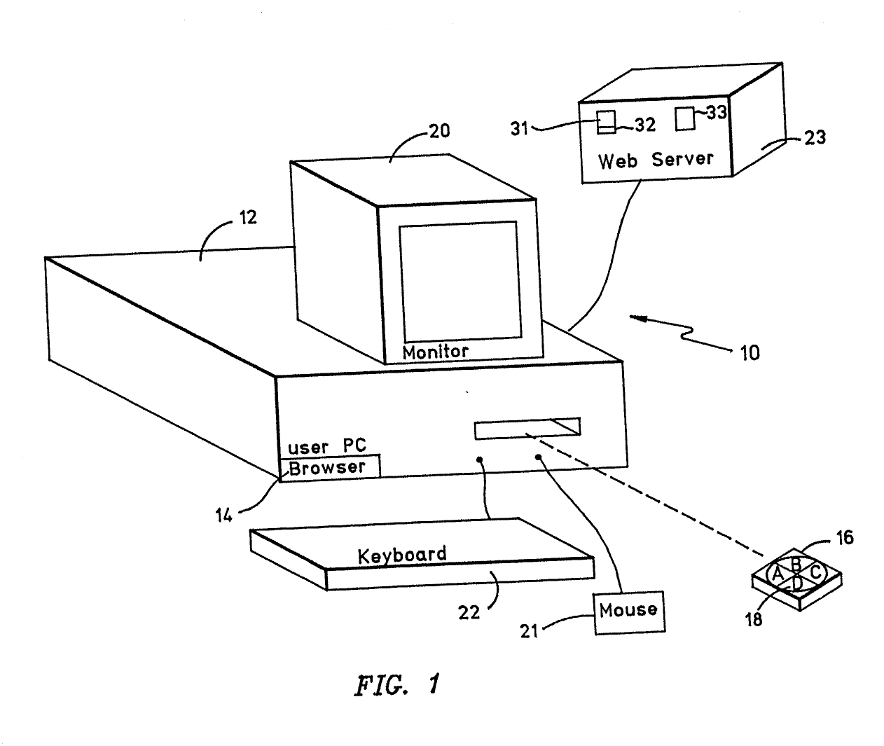

Referring initially to FIG. 1, a system for presenting a help window on a web page display is shown, generally designated 10. In the particular architecture shown, the system 10 includes a digital processing apparatus, such as a computer 12. In one intended embodiment, the computer 12 may be a personal computer made by International Business Machines Corporation (IBM) of Armonk, N.Y., or the computer 12 can be any computer capable of running a web browser, including computers sold under the AS400 trademark, with accompanying IBM Network Stations add-ons. Alternatively, the computer 12 may be a machine capable of running a web browser concurrently with a server; such machines include a Unix computer, or OS/2 server, or Windows NT server, or IBM RS/6000 250 workstation with 128 MB of main memory running AIX 3.2.5.

As shown, the computer 12 includes a software-implemented network navigation program, referred to herein as a “browser” 14, which may be executed by a processor within the computer 12 as a series of computer-executable instructions. These instructions may reside, for example, in RAM of the computer 12.

Alternatively, the instructions may be contained on a data storage device with a computer readable medium, such as a computer diskette 16 shown in FIG. 1. Or, the instructions may be stored on a DASD array, magnetic tape, conventional hard disk drive, electronic read-only memory, optical storage device, or other appropriate data storage device.

In an illustrative embodiment, the invention may be embodied in computer-executable instructions that may be stored in, or with the web browser 14, or may be lines of hypertext mark-up language (HTML) compatible code, such as JavaScript, shipped to the computer 12 over a network.

FIG. 3 illustrates the structure of the invention embodied in a computer program. Those skilled in the art will appreciate that FIG. 3 illustrates the structures of computer program code elements that function according to this invention. Manifestly, the invention may be practiced in its essential embodiment by a machine component that renders the computer program code elements in a form that instructs a digital processing apparatus (that is, a programmed, general purpose digital computer) to perform a sequence of function steps corresponding to those shown in the Figures. The machine component is shown in FIG. 1 as a combination of program code elements A-D in computer readable form that are embodied in a computer-usable data medium 18, on the computer diskette 16. As mentioned above, however, such media can also be found in semiconductor devices, on magnetic tape, and on optical disks. Alternatively, such instructions may be obtained from another machine, over a network.

As per FIG. 1, the system 10 preferably includes peripheral computer equipment known in the art, including an output device such as a video monitor 20 and an input device such as a computer keyboard 22. Other output devices can be used, such as printers, other computers, and so on. Likewise, input devices other than or in addition to the keyboard 22 can be used, e.g., trackballs, keypads, touch screens, and voice recognition devices. One such other input device is illustrated in FIG. 1 as a mouse 21.

In accordance with the present invention, among other applications the computer 12 can access a server computer 23 via a network such as the wide area computer network known as the Internet. Preferably, the portion of the Internet that is applicable to the present invention is the World Wide Web, and the server computer 23 executes a web server that provides to user computers information on demand in the form of so-called web pages.

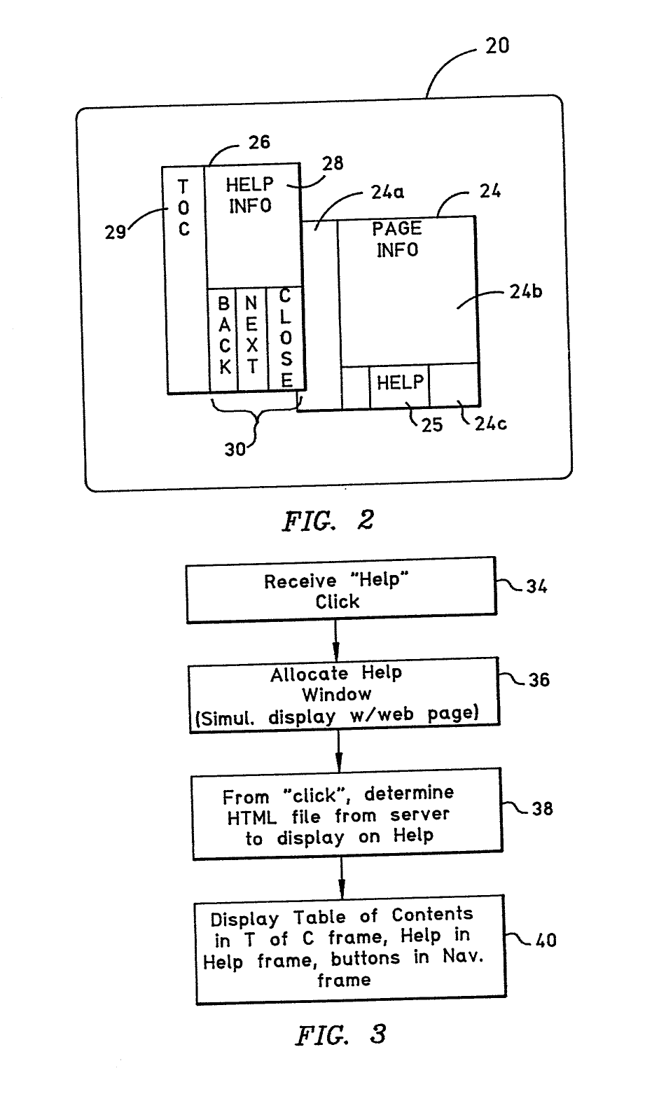

Referring to FIG. 2, the help feature of the present invention can be graphically seen. As shown, the monitor 20 presents a graphical display area 24 (a “window”) that displays a web page when the computer 12 communicates with the server computer 23 and receives data on the web page therefrom. The web page window 24 shown in FIG. 2 includes a textual or graphical representation of a help function. In the preferred embodiment, this is provided by a help button 25. The user can position the cursor of the display over the help button 25 and generate a help signal by “clicking” on the mouse 21 or depressing an enter key on the keyboard 22 (FIG. 1), to thereby invoke the help feature of the present invention.

FIG. 2 shows that when the help feature has been invoked as described above, a help window, generally designated 26, is created and is displayed on the monitor 20. Importantly, as shown in FIG. 2 the help window 26 is displayed simultaneously with the web page window 24. Thus, the user of the computer 12 can simultaneously view both the web page window 24 and the help window 26.

As shown in FIG. 2, the help window 26 includes a rectangular help information frame 28. In accordance with the present invention, the help frame 28 contains information pertaining to the operation and/or maintenance not of the browser 14, but to the contents presented on the web page display 24, as provided by the server computer 23.

Preferably, the help window 26 displays information related to the web page window 24, describing how to use various functions or how to do various operations that are available via the web page window 24.

The help window 26 includes a rectangular table of contents frame 29 and a rectangular navigation frame 30. As shown, both the table of contents frame 29 and the navigation frame 30 are contiguous to the help frame. Specifically, in one presently preferred embodiment, the table of contents frame 29 is on the left side of the help information frame 28, whereas the navigation frame 30 is below the help frame 28.

In accordance with the present invention, the table of contents frame 29 presents a table of contents to other items that pertain to the information in the help information frame 28. By “clicking” on an item in the table of contents frame, a user is hyperlinked to the item. In other words, the server computer 23 receives the “click” and in response transmits the new help item to the computer 12 for presentation thereof in the help information frame 28. Stated differently, the table of contents frame 29 presents hypertext links to hypertext help files pertaining to the web page on the display 24. In effect, the table of contents frame 29 presents at least a portion of a hierarchical map of the stored help text.

In contrast to the table of contents frame 29, the navigation frame 30 contains navigation aids, such as a “back” button, a “next” button, and a “close” button. The back and forward buttons, when selected, respectively cause the previous or subsequent help information display to be presented in the help information frame 28. The close button terminates the help feature and deallocates the help window 26.

In the preferred embodiment and best mode of this invention, when an initial web page is provided as a file 31 sent by the server computer 23 to the browser, a set of instructions 32 is included in the file. The set of instructions 32 is executable by the computer 12 and is for displaying graphics that comprise the help window 26. When the help button 25 is clicked, the set of instructions 31 is invoked and the help window 26 is displayed. At the same time, the click causes the computer 12 to request a second file (help file) 33 from the server computer 23 whose contents comprise information that is displayed in the help window 26. The contents of the help file 33 are specific to the web window (panel) currently being displayed. For any web site, the set of instructions 32, when executed by the computer 12, maintains a parameter whose value identifies the web site panel currently being displayed. When the help button 25 is clicked, the request to the server computer 23 for help window information identifies the panel so that the file 33 sent to the computer 12 contains the correct information.

Although this specific arrangement is used in the preferred embodiment, those skilled in the art will realize that the instruction set may be stored initially at the computer 12, from a source other than the server 23. Further, the help window information file 33 could be provided from another source than the file 33. For example, it could be provided as part of the file 31. Alternatively, all of the possible help files for a particular web site could be stored in or at the computer 12, by being down loaded from the server 33, or from another node.

FIG. 3 shows a flow chart of the operations discussed above. At step 34, the help signal is generated and invokes execution of the instruction set 32 by the computer 12. As a result of execution at step 36, the present invention allocates and displays the help window 26 (FIG. 2). For example, the present invention might allocate a 480×420 block of pixels of the monitor 20 for use as the help window 26. As discussed above and shown in FIG. 2, however, at least a portion (if not all) of the web page window 24 continues to be displayed on the monitor 20.

At step 38, the present invention determines the identity of the web panel for which help is sought in order to identify to the server computer 23 from which the HTML help file is to be downloaded for display in the help window 26. Then, at step 40 the table of contents pertaining to the downloaded information is displayed in the table of contents frame 29, and the help information is displayed in the help information frame 28. Likewise, the navigation buttons discussed above are displayed in the navigation frame 30. The help window 26 remains displayed until the user clicks on the close button in the navigation frame 30.

In our preferred embodiment of FIG. 2, there are three frames within the web page window 24. The frame 24a is a task frame where users select a task to work on, the main frame 24b is a work area where users select choices, and the button frame 24c contains buttons for acting on the work area (back, next, and finish, in addition to help). The button frame 24c is set specifically for each work area instance and contains a variable that identifies help information that should be shown if the Help button 25 is pressed. So, for example, if the user selects ‘Hardware’ from the task frame 24a, the main work area frame 24b would change to an instance showing the ‘Hardware’ settings, and the button frame 24c would also be changed as follows:

function loadHardwareButtonFrame( ) {

parent.selectedHelp = “ScopeHardware”
parent.buttonFrame.document.open( )
parent.buttonFrame.document.write(buttonDoc1 + termNextButton + buttonDoc1Cont)
parent.buttonFrame.document.close( )
initTermFrm(parent.mainFrame.document.scopeForm)

}

The above instructions say that when the hardware function is called, the variable parent.selectedHelp is set to ScopeHardware and then the button frame is created by appending the following instructions together:

buttonDoc1 = “<HTML><HEAD></HEAD><BODY BGCOLOR=‘#FFFFFF’><FORM>
<CENTER>”

+ “<TABLE WIDTH=100%CELLPADDING=0CELLSPACING=0><TR>”
+ “<TD WIDTH=40%><BR></TD><TD WIDTH=10%ALIGN-CENTER><A

HREF=‘JavaScript:parent.previousFromScope( )’”

+“onMouseOver=‘window.status=parent.previousMsg;return true’>”
+“<IMG SRC=”+previousLoc+“border-0><BR>”
+“<FONT SIZE=2>Back</FONT></A><TD>”
+“<TD ALIGN=CENTER WIDTH--10%<>AHREF=”

termNextButton=“‘JavaScript:parent.subTermFrm(parent.mainFrame.document.scopeForm)’”
buttonDoc1Cont=“onMouseOver=‘parent.window.status=parent.nextMsg;return true’>”

+“<IMG SRC=”+nextLoc+“border-0><BR>”
+“<FONT SlZE=2>Next</FONT></A></TD><TD WIDTH=20%><BR></TD>”
+“<TD WIDTH=20%ALIGN=CENTER><A HREF=‘JavaScript:parent.showHelp

(parent.selectedHelp)’”

+“onMouseOver=‘window.status-parent.helpMsg;return true’>”
+“<FONT SIZE=2>Help</FONT></A></TD>”
+ “</TR></TABLE>”

When the user selects the Help pushbutton 25, the function parent.showHelp(parent.selectedHelp) is run. This function opens the Help window 26, sets the size of the window and establishes the options (no toolbar, resizable, etc.).

function showHelp(name) {

//handler for the help pushbutton
var url = parent.startingDir + “helpfrm.htm”
var helpWindowName = “helpWindow”
var helpWindowOptions =

“toolbar=no.membar=yes.scrollbars=yes.resizable=yes.directories=no.status=yes.height=
405.width=400”

helpWindow=window.open (url, helpWindowName, helpWindowOptions)
if (parent.javaScriptFun==“FULL”)

{
helpWindow.focus( )
}

}

The help window is named (helpWindow) which allows later reference to this same window. The helpWindow.focus( ) function provides the ability to bring the help window back in focus when the help window is requested again, without opening a new window (as would happen if the window were not named). So, for example, if the help window was already open, and the user went back to the browser window with the application in it, pressing the help button would bring the same help window forward, in focus.

The help window structure is defined by the helpform.htm file. This file contains three HTML Frameset instructions to create the three frames in the help window as shown in FIG. 2, that is the contents frame 29, information frame 28, and navigation frame 30. When the first frame is created, it runs the loadHelpWindow( ) function. The loadHelpWindow( ) function conditionally sets the variable helpFrameText to the correct HTML help file to display based on the value of parent.selectedHelp. After finding the correct HTML file to load, the function loadFrames( ) is called. The loadFrames( ) function loads in the correct HTML files into the three frames. Remember, the value of parent.selectedHelp is set when the button frame in the main window is loaded and provides information on which panel is being displayed to the user. So, for instance, when the user “clicks” the help button on the hardware panel, parent.selectedHelp equals ‘ScopeHardware’. In response to the click the Help window 26 is created, the loadHelpWindow function is run and parent.selectedHelp is evaluated. If it equals ‘ScopeHardware’ then the file ‘termscp.htm’ is requested and obtained from the server (in the help file 33 of FIG. 1) and its contents are loaded into the HelpTextFrame. The file ‘termscp.htm’ contains the help information for the panel the user is on.

Frame Set Instructions:

</HEAD>

<FRAMESET COLS=“30%,70%” ONLOAD=“loadHelpWindow( )”>

<FRAME SRC=button.htm NAME=“HelpIndexFrame”>

<FRAMESET ROWS=“85%,15%”>

<FRAME SRC=button.htm NAME=“HelpTextFrame”>
<FRAME SRC=button.htm NAME=“HelpNavigationFrame” SCROLLING=NO>

</FRAMESET>

</FRAMESET>

</HTML>

Function loadHelpWindow( ):
function loadHelpWindow( )

{

var url = parent.opener.parent.startingDir
if (window.opener.parent.selectedHelp = = “ScopeHardware”)

{
helpFrameText = “termscp.htm”
}

else if(window.opener.parent.selectedHelp = = “functionX”)

{
helpFrameText =“functXhlp.htm”
}

more else if statements go here to evaluate other application panels

loadFrames (url, helpFrameText)
}
Function loadFrames( ):
function loadFrames(url, helpFrameText)

{

window.frames[0].location=url+“hipuidx.htm”
window.frames[1].location=url+helpFrameText
window.frames[2].location=url+“hplnav.htm”

}

The other frames in the help window are the help contents and the help navigation buttons. The help contents are created with the following code obtained from the server in the help file 33:

<BODY BGCOLOR= “#FFFFFF”>
<FONT SIZE=2>
<H3>Contents</H3>
<DL>
<A HREF=“overhlp.htm”TARGET=“HelpTextFrame”>Overview</A></P>
<DT COMPACT>Hardware
<DD><A HREF=“termsep.htm”TARGET=“HelpTextFrame”>Overview</A>
<DD><A HREF=“termhlp.htm”TARGET=HelpTextFrame”>Detail</A>
</DT>
<DT COMPACT>Function X
<DD><A HREF=“functXscp.htm”TARGET=“HelpTextFrame”>Overview</A>
<DD><A HREF=“functXhlp.htm”TARGET=“HelpTextFrame”>Detail</A>
</DT>
<DT COMPACT>More things go here
<DD><A HREF=“morehelp.htm”TARGET=“HelpTextFrame”>Overview</A>
<DD><A HREF=“morehelp2.htm”TARGET=“HelpTextFrame”>Detail</A>
</DT>
</FONT>
</DL>
</BODY>
</HTML>

The above code says that when a user clicks on one of the links (such as ‘Overview’) the file overhlp.htm should be written to the frame ‘HelpTextFrame’ of the help window.

The navigation frame is created with the following code obtained from the server in the help file 33:

</SCRIPT>
</HEAD>
<BODY bgcolor= “#FFFFFF”text=“#0000FF”>
<FORM NAME=“HelpNavigationFrame”ACTION=“”METHOD “POST”>
<CENTER>
<TABLE CELLPADDING=0 CELLSPACING=0><TR>

<TD ALIGN=CENTER><A HREF=‘JavaScript:parent.top.frames[1].history.back( )’

onMouseOver=‘parent.window.status-parent.self.opener.previousHelpMsg; return

true’>

<IMG SRC=“../image/previous.gif” “border=0><BR>
<FONT SIZE=2>Back</FONT></A><TD><BR><TD>

<TD ALIGN=CENTER><A HREF=‘JavaScript:parent.top.frames[1].history.forward( )’

onMouseOver=‘parent.window.status=parent.self.opener.nextHelpMsg:return true’>
<IMG SRC=“./image/next.gif” border=0><BR>
<FONT SIZE=2>Next</FONT></A></TD><TD><BR><TD>

<TD><BR><TD><TD><BR><TD>
<TD ALIGN=CENTER><A HREF=‘JavaScript:parent.window.close( )’

onMouseOver=‘parent.window.status=parent.self.opener.closeHelpMsg: return true’>

<IMG SRC=“../image/close.gif” border=0><BR>

<FONT SIZE=2>Close</FONT></A></TD>
</TR></TABLE>

</CENTER>
</FORM>
</BODY>
<HTML>

This code creates three buttons in the HelpNavgationFrame—a Back button, a Next button, and a Close button. The Back button takes the user back in history one link. So for instance, if the user has selected three different links from the text within the help window, the Back button will take the user back successively through these links. The Next button moves the user forward to the next link once a user has gone back. The Close button closes the window.

The following shows the structure of the help information that is obtained in the help file 33 and displayed within the HelpTextFrame.

<A NAME=“HARDWARE”><h3><CENTER>Help for Hardware Settings</CENTER></h3></A>
<p>
general information goes here about panel and indicating that the following fields can be set
<UL>
<LI><A HREF=“termhlp.htm#Field1”>Field 1</A>
<LI><A HREF= “termhlp.htm#Field2”>Field 2</A>
</UL><P>
Use the<A NAME=“Field1”>Field1</A> information on field 1.
<p>
information goes here
<P>Use the <A NAME=“Field2”>Field 2</A>information on Field 2.
<p>
information goes here

The help information may be structured any way that best meets the needs of the user and application. We have chosen to provide general help in a first paragraph, and then list the controls on the panel. The user can click on the items in the list and be taken to more detailed information about the field. As stated previously, the user can also click on one of the topics on the contents frame and a new file will be listed in the help text frame based on the topic the user selected. This makes the Help window very interactive—the user can get to any help needed (detailed or general) in a very efficient manner.

While the particular METHOD AND APPARATUS FOR DISPLAYING HELP WINDOW SIMULTANEOUSLY WITH WEB PAGE PERTAINING THERETO as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims.

We claim:

1. A computer with a data storage device including a computer usable medium having computer usable code to present a help window on a web page displayed on a monitor, the computer usable code comprising:
first computer readable code to present on the monitor a web page obtained from a server;
second computer readable code to receive a help signal for the web page;
third computer readable code to allocate a portion of the monitor for a help window, in response to the help signal; and
fourth computer readable code to present information in the help window pertaining to the web page, wherein the information in the help window describes how to accomplish functions in the web page.

2. The computer of claim 1, wherein the help window is displayed simultaneously on the monitor with at least a portion of the web page.

3. The computer of claim 1, wherein the help window includes a help frame, and a table of contents frame contiguous to the help frame and pertaining thereto.

4. The computer of claim 3, wherein the help window further includes a navigation frame contiguous to at least one of the table of contents frame and the help frame.

5. The computer of claim 1, wherein the third and fourth computer readable code means are obtained from the server.

6. The computer of claim 5, wherein the information in the help window is obtained by the computer in a file from the server.

7. The computer of claim 5, wherein the table of contents frame presents hypertext links to hypertext help files pertaining to the web page.

8. In a user computer connected via a network to a server, the user computer comprising:
a browser to present a web page from the server on a monitor; and
computer readable code to present a help window on the monitor, the help window containing information pertaining to the web page from the server computer and not to the browser means, wherein the information in the help window describes how to accomplish functions in the web page.

9. The user computer of claim 8, wherein the user computer readable code presents the help window in response to a user-generated help signal.

10. The user computer of claim 9, wherein the computer readable code presents the help window simultaneously on the monitor with at least a portion of the web page.

11. The user computer of claim 9, wherein the help window includes a help frame, and a table of contents frame contiguous to the help frame and pertaining thereto.

12. The user computer of claim 11, wherein the help window further includes a navigation frame contiguous to at least one of the table of contents frame and the help frame.

13. The user computer of claim 12, wherein the table of contents frame presents hypertext links to hypertext help files pertaining to the web page.

14. A computer-implemented method for presenting a help window on the display area of a monitor associated with a user computer along with at least a portion of a web page obtained from a server by a browser in the user computer via a wide area network, comprising:
downloading the web page from the server;
receiving a help signal;
in response to the help signal, allocating a portion of the display area for a help window; and
presenting help information on the help window, the help information pertaining to the web page, wherein the information in the help window describes how to accomplish functions in the web page.

15. The method of claim 14, further comprising:
dividing the help window into a help frame and a table of contents frame contiguous to the help frame and pertaining thereto.

16. The method of claim 15, further comprising dividing the help window into a navigation frame contiguous to at least one of the table of contents frame and the help frame.

17. The method of claim 14, wherein the table of contents frame presents hypertext links to hypertext files pertaining to the web page.

18. The method of claim 14, further comprising obtaining the help information in a file from the server.

19. A computer program device comprising:
a program storage device readable by a digital processing apparatus; and
a program on the program storage device and including instructions executable to cause the digital processing apparatus to present on a monitor associated with a user computer that executes a browser help information simultaneously with a page obtained by the browser from a server by:
presenting a web page from the server on the monitor associated with the user computer; and
selectively presenting a help window on the monitor associated with the user computer, the help window containing information pertaining to the web page from the server computer, wherein the information in the help window describes how to accomplish functions in the web page.

20. The computer program device of claim 19, wherein the program is further to cause the digital processing apparatus to present the help window in response to a user-generated help signal.

21. The computer program device of claim 20, wherein the program is further to cause the digital processing apparatus to present the help window simultaneously on the monitor with at least a portion of the web page.

22. The computer program device of claim 21, wherein the program is further to cause the digital processing apparatus to present in the help window a help frame, and a table of contents frame contiguous to the help frame and pertaining thereto.

23. The computer program device of claim 22, wherein the program is further to cause the digital processing apparatus to present in the help window a navigation frame contiguous to at least one of the table of contents frame and the help frame, the table of contents frame presenting hypertext links to hypertext files pertaining to the web page.

24. A method of providing help information for a browser site monitor that displays a web site page, the help information containing information relevant to the web site page, the method including the server-executed steps of:
receiving from a browser a request for a web site page;
returning to the browser the requested web site page and computer-executable instructions for displaying a help window containing information relevant to the web site page, wherein the information in the help window describes how to accomplish functions in the web page;
receiving from the browser a request for information to be displayed in a help window corresponding to a function of the web site page; and
returning to the browser a file containing the requested information.

25. A method of presenting help information on a browser site monitor that displays a web site page, the help information containing information relevant to the web site page, the method including the computer-executed steps of:
providing from a browser site a request to a server for a web site page;
receiving at the browser site the web site page together with computer-executable instructions for displaying a help window containing information relevant to the web site page;
displaying the web site page on a browser site monitor;
receiving a help request at the browser site for a function of the web site page;
providing from the browser site a request to the server for help information relevant to the function, wherein the information in the help window describes how to accomplish functions in the web page;
receiving the help information at the browser site; and
displaying the help information in a help window on the browser site monitor.
